(19) United States
(12) Patent Application Publication
(10) Pub. No.: US 2008/0247925 A1
(43) Pub. Date: Oct. 9, 2008

(54) SEPARATION AND RECOVERY OF PRECIOUS METALS USING POLYMER MATERIALS

(75) Inventors: Gordon Wallace, Gwynneville (AU); Stephen Ralph, Farmborough Heights (AU); Jie Ding, Keiraville (AU); Will Price, Gerringong (AU)

Correspondence Address: WOLF GREENFIELD & SACKS, P.C., 600 ATLANTIC AVENUE, BOSTON, MA, 02210-2206, US

(73) Assignee: University of Wollongong, Wollongong (AU)

(21) Appl. No.: 12/139,804

(22) Filed: Jun. 16, 2008

Related U.S. Application Data
(63) Continuation of application No. 10/492,737, filed on Feb. 11, 2005.

(30) Foreign Application Priority Data
Oct. 16, 2001 (AU) PR 8311

(51) Int. Cl. B01D 11/02

(52) U.S. Cl. 423/24

(57) ABSTRACT

A method of separation and/or recovery of a precious metal from a solution containing said precious metal in ionic form, optionally in the presence of impurities, including the step of contacting a solution containing said precious metal in ionic form with a conducting polymer. The method is generally applicable to precious metals including platinum (Pt), palladium (Pd) and more particularly gold (Au). The ionic species may be anionic (for example [AuCl.sub.4].sup.-) or cationic. The polymer may be for example, a polypyrrole or polythiophene, optionally doped and are preferably in a high surface area form eg. coated onto cloth or RVC or in self supporting colloidal form. The polymer may also contain species to give further functionality, eg magnetic or heat sensitive species.

### TECHNICAL FIELD

The invention relates to methods of separation and recovery of precious metals, in particular, gold, and to apparatus for carrying out said methods.

### BACKGROUND ART

The separation and recovery of precious metals including gold, from industrial process solutions has been investigated for many years. There are several techniques used for gold recovery, the most widely used of which is the carbon adsorption method for the recovery of gold from cyanide solutions. Although this technique is well established, it still suffers from several drawbacks.

Gold is very stable, as indicated by its lack of reactivity in air and most aqueous solutions. Gold only dissolves in oxidizing solutions containing certain complexing ligands and only a limited number of ligands form complexes (such as cyanide, chloride and thiourea ions) of sufficient stability for use in gold extraction.

Cyanide is still universally used in gold extraction processes because of its relatively low cost and great effectiveness for gold dissolution. However, cyanide can pose a high risk to health and the environment. In aqueous, alkaline cyanide solution gold is oxidized and dissolves to form the Au(I) cyanide complex, Au(CN)₂⁻. The Au(III) cyanide complex, Au(CN)₄⁻, is also formed but the Au(I) complex is more stable.

Due to the potential toxicity of cyanide, the recovery of gold from cyanide-free containing solutions is an important consideration in the development of possible alternative gold leaching systems. Non-cyanide reagent schemes have several potential advantages over the use of cyanide. Environmental pressures, and in some cases restrictions, may make the application of cyanide difficult in certain locations. Some alternative ligands have faster gold leaching kinetics. Many can also be applied in acidic media, which may be more suitable for refractory ore treatment, and some others are more selective than cyanide for gold over other metals.

Gold halogenation and extraction from acid solution using reagents other than cyanides has attracted considerable attention during the last two decades.

Methods using chloride or thiosulphate leaching have also been investigated as this recovery route does not have the adverse environmental effect of cyanidation. Chloride has been investigated extensively, and several potential processes have been developed. Aqueous solutions of chlorine have strong oxidizing capabilities and have been used widely as oxidants in water and waste treatment. Gold dissolved in aqueous chloride solution to form both the Au(I) and Au(III) chloride complexes. The Au(III) complex is more stable than Au(I) species.

Zinc precipitation or ‘cementation’ of gold has been applied widely in the industry and have been used to treat the more concentrated gold cyanide solution produced by carbon elution, or direct recovery from dilute solution. For example, the technique of gold recovery by cementation with zinc was established practice until about 1975. However, zinc is unsuitable for cementation from acidic solutions since it is highly soluble in acid, evolving large quantities of hydrogen and resulting in prohibitively high consumptions of the metal.

The use of non-cyanide containing solution systems for gold leaching is not commonly practiced. At the turn of the century, the chlorination of gold ores was practised to supplement gravity recovery. The gold was precipitated from solution by charcoal, ferrous sulphate or hydrogen sulphide. However, this process was rarely used to treat whole ores due to the high cost—which resulted in high cut off grades. The development of cyanidation surpassed the use of chlorine gas due to its amenability to treat lower grade gold ores with finer gold.

Although there have been a few previous studies concerning the interactions between conducting polymers and [AuCl₄]⁻, most of these have not examined in detail the potential for the method to be used on an industrial scale. In addition none of the studies examined gold uptake from solutions that simulated accurately industrial gold-containing solutions. In particular, none have investigated the particular problem of competing chemical species that are inevitably present in industrial gold bearing solutions.

Due to a growing interest in alternative methods for more economic and effective gold recovery, new methods and technologies are being considered. One of these new methods involves the use of conducting polymers.

This process involves immersing a sample of the polymer in a gold-containing solution. Reduction and deposition of the metal ion to the element on the polymer occurs, with a simultaneous increase in the oxidation state of the polymer. While the interactions of cyanide complexes of gold with conducting polymers have not previously been reported, several studies into the interactions of AuCl₄⁻ with Ppy and Pan have appeared.

However, it was also found that deposition of gold onto the conducting polymer was limited by polymer surface area.

Any discussion of the prior art throughout the specification should in no way be considered as an admission that such prior art is widely known or forms part of common general knowledge in the field.

### DESCRIPTION OF THE INVENTION

According to a first aspect the invention provides a method of separation and/or recovery of a precious metal from a solution containing solid precious metal in ionic form including the step of contacting a solution containing said precious metal in ionic form with a conducting polymer.

According to a second aspect, the invention provides a conducting polymer for the separation and/or recovery of a precious metal from a solution containing a said precious metal in ionic form.

The solution containing the precious metal may further contain impurities.

Preferably, polymer is in high surface area form and the separation and/or recovery is by the precipitation of the precious metal.

The precious metal is most preferably gold (Au) but may be any precious metal, for example, platinum (Pt) or palladium (Pd).

The invention is disclosed with specific reference to Au, although it will be appreciated by those skilled in the art that the inventive concept applies also to other precious metals.

Where the precious metal is gold, it is preferably recovered from an anionic gold species [AuXₙ] which may be written as [AuXₙ]^{q-}. Preferred anionic gold species include gold halides of the form [AuXₙ]^{q-} (for instance, gold fluoride, gold bromide, gold iodide, and most preferably gold chloride, [AuCl₄]⁻), gold cyanide [Au(CN)₂]⁻, or gold sulphur complexes. Preferred gold sulphur complexes include gold thiosulfate [Au(S₂O₃)₂]³⁻, or gold thiocyanate [Au(SCN)₂]⁻ or [Au(SCN)₄]⁻. Other polysulfides may be used.

The gold may be complexed with an organic ligand and/or may be in the form of a cationic gold species. The most preferred organic ligand is thiourea, although other organic ligands may be employed, for example malonitrile, acetonitrile or other organic sulphur compounds.

Preferably, the conducting polymer is in self supporting form, such as in the form of a polymer membrane or a polymer dispersion or powder.

Also preferably, the conducting polymer is in the form of a coating on a support substrate such as a coated fibre (eg a carbon fibre) or a coated particle (eg a carbon particle).

More preferably, the conducting is coated onto a rigid material. Rigid materials can include simple metals or porous metal forms. A highly preferred support for carrying out the methods of the present invention is reticulated vitreous carbon (RVC).

The conducting polymer may be contacted with the gold bearing solution in a colloidal form, either as a self supporting colloidal dispersion or as a colloidal dispersion of coated particles or microparticles.

In alternative preferred embodiments, the conducting polymer is coated onto a flexible material, which for preference is a textile, cloth or fabric. The textile cloth or fabric is preferably selected from lycra, nylon-lycra, cotton-lycra, cotton, polyester, wool, carbon cloth or mixtures thereof.

In another preferred embodiment, the conducting polymer is coated onto a resin. For preference, the resin is magnetic. By the term magnetic resin is meant any resin having sufficient magnetic susceptibility to facilitate magnetic separation. Magnetic susceptibility may preferably be conferred by the dispersion of magnetic particles within the resin. Magnetic resins of the MIEX® type, as developed by CSIRO and Orica, are also particularly suitable.

Preferably, the conducting polymer is based on a 5-membered heterocycle and may for preference be, polypyrrole, polythiophene, polybisthiophene or poly 3-methythiophene.

Also preferred are aromatic conducting polymers, most preferably polyaniline.

Preferably the conducting polymer contains a dopant selected from one or more of an PTS, S-PHE (sulfonated β-hydroxyether), or other organic dopants, or inorganic dopants such as chloride (Cl⁻) or perchlorate (ClO₄⁻) ions.

Where the gold is in a cationic form (such as [Au(thiourea)₂]⁺), preferably the dopant in the conducting polymer is an anionic polyelectrolytes.

In one highly preferred embodiment, poly NiPAAM/AMP (poly(isopropyl acrylamide)-poly(acrylamido)-2-methylpropane sulfonic acid) is the dopant and the conducting polymer is provided in colloidal form, thereby providing a thermally sensitive colloidal dispersion recoverable by heating.

According to a third aspect, the present invention provides a conducting polymer in self supporting form for the separation and/or recovery of a precious metal from a mixture containing the precious metal in ionic form.

Preferably the polymer is in a form with a high surface area per unit volume.

Preferably, the conducting polymer is in the form of a polymer membrane, polymer dispersion, colloidal dispersion or powder.

According to a fourth aspect, the present invention provides a conducting polymer in the form of a coating on a support substrate for separation and/or recovery of a precious metal from a mixture containing the precious metal in ionic form.

Again, preferably the polymer is in a form with a high surface area per unit volume. Preferably, the conducting polymer in the form of a coated fibre or particle (such as a carbon fibre or particle) or a coated colloidal dispersion.

Preferably, the separation and/or recovery is by the precipitation of the precious metal.

The precious metal is most preferably gold (Au) but may be any precious metal, for example, platinum (Pt) or palladium (Pd).

More preferably, the conducting polymer in high surface area form is coated onto a rigid material. Rigid materials can include simple metals or porous metal forms. A highly preferred support for carrying out the methods of the present invention is reticulated vitreous carbon (RVC).

The conducting polymer may be in a colloidal form, either as a self supporting colloidal dispersion or as a colloidal dispersion of coated particles or microparticles.

In alternative preferred embodiments, the conducting polymer in high surface area form is coated onto a flexible material, which for preference is a textile, cloth or fabric. The textile cloth or fabric is preferably selected from lycra, nylon-lycra, cotton-lycra, cotton, polyester, wool, carbon cloth or mixtures thereof.

In further preferred embodiments, the conducting polymer is coated onto a resin, preferably a magnetic resin.

Preferably, the conducting polymer is based on a 5-membered heterocycle and may for preference be, polypyrrole, polythiophene, polybisthiophene or poly 3-methythiophene.

Also preferred are aromatic conducting polymers, most preferably polyaniline.

Preferably the conducting polymer contains a dopant selected from one or more of an PTS, S-PHE (sulfonated β-hydroxyether), or other organic dopants, or inorganic dopants such as chloride (Cl⁻) or perchlorate (ClO₄⁻) ions.

Where the gold is in a cationic form (such as [Au(thiourea)₂]⁺), preferably the dopant in the conducting polymer is an anionic polyelectrolytes.

In one highly preferred embodiment, poly NiPAAM/AMP is the dopant and the conducting polymer is provided in colloidal form, thereby providing a thermally sensitive colloidal dispersion recoverable by heating.

The invention also relates to the use of a conducting polymer for the preparation of a precious metal from a solution containing said precious metal in ionic form.

In another aspect, the invention provides a precious metal, preferably gold, when obtained according to methods of the present invention, or by use of the conducting polymers of the present invention.

The gold is preferably recovered from an anionic gold species, most preferably one of the form [AuXₙ]. Preferred anionic gold species include gold halides of the form [AuXₙ]⁻ (for instance, gold fluoride, gold bromide, gold iodide, and most preferably gold chloride, [AuCl₄]⁻), gold cyanide [Au(CN)₂]⁻, or gold sulphur complexes. Preferred gold sulphur complexes include gold thiosulfate [Au(S₂O₃)₂]³⁻, or gold thiocyanate [Au(SCN)₂]⁻ or [Au(SCN)₄]⁻. Other polysulfides may be used.

The mechanism for gold recovery from [AuCl₄]⁻ involves ion exchange to preconcentrate and redox reactions to recover the gold from solution as the metal.

The gold may be derived from a form complexed with an organic ligand and/or may be in the form of a cationic gold species. The most preferred organic ligand is thiourea, although other organic ligands may be employed, for example malonitrile, acetonitrile or other organic sulphur compounds.

### BRIEF DESCRIPTION OF THE DRAWINGS

FIG. 1. Cell design used for preparing conducting polymer coated RVC electrodes.

W: RVC cube working electrode (1 cm×1 cm×4 cm).
A: RVC cylinder (or tube) auxiliary electrode (h=5 cm, d=3 cm, d+n=3.5 cm, n is thickness of the tube).
R: Reference electrode Ag/AgCl (3 M NaCl_{(a,q)}) or Ag/Ag⁺ (3M TBAP in CH₃CN).
S: Salt bridge (3 M NaCl or 3 M TBAP).

FIG. 2. Uv-vis spectra of PBT/S-PHE composites galvanostatically deposited (1 mA/cm² for 50 s) onto ITO coated glass (a) Polymer in the reduced state; (b) Polymer in (a) after immersion in a solution containing 0.01 M [AuCl₄]⁻ and 0.1 M HCl; (c) Polymer in the oxidised state; (d) Polymer in (c) after immersion in a solution containing 0.01 M [AuCl₄]⁻ and 0.1 M HCl.

FIG. 3 (a). Scanning electron micrograph of the solution side of a PPy/PTS membrane.

FIG. 3 (b). Scanning electron micrograph of the solution side of a PPy/PTS membrane after exposure to a solution containing 4000 ppm [AuCl₄]⁻ for 2 hours.

FIG. 3 (c). Scanning electron micrograph of the solution side of a PPy/PTS membrane after it had been immersed in a solution containing 4000 ppm [AuCl₄]⁻ for 20 hours.

FIG. 4. Recovery of gold by polymer modified RVC from solutions containing 0.1 M HCl and varying initial concentrations of [AuCl₄]⁻.

(O)=polymer initially in the oxidized state.
(R)=polymer initially in the reduced state.
a=initial gold concentration 1 ppm.
b=initial gold concentration 5 ppm
c=initial gold concentration 100 ppm

d=initial gold concentration 1000 ppm.

FIG. 5. Recovery of gold from solutions containing 0.1 ppm [AuCl₄]⁻ and 0.1 M HCl by different conducting polymer modified RVC. (O)=polymer initially in the oxidized state. (R)=polymer initially in the reduced state. All experiments were performed for 20 h.

FIG. 6. Recovery of gold from a solution containing 0.1 ppm [AuCl₄]⁻ and 0.1 M HCl by PPy/PTS.

FIG. 7. Effect of temperature on recovery of gold from a 0.1 M HCl solution containing 1000 ppm [AuC₄]⁻, using oxidised PPy/PTS membranes.

FIG. 8. Effect of variations in PPy/PTS membrane thickness on gold recovery from solutions containing 0.1 M HCl and 1000 ppm [AuCl₄]⁻.

FIG. 9. Recovery of gold from a solution containing 1 ppm [AuCl₄]⁻, 1000 ppm Fe(III) and 0.1 M HCl, using oxidized PPy/PTS/RVC.

FIG. 10. Recovery of gold from a solution containing 1 ppm [AuCl₄]⁻, 1000 ppm Fe(III) and 0.1 M HCl, using oxidized PMT/ClO₄/RVC.

FIG. 11. Recovery of gold from a solution containing 1 ppm [AuCl_{4]}⁻, 3000 ppm Fe(III), 3000 ppm Fe(II) and 0.1 M HCl, using oxidized PPy/PTS/RVC.

FIG. 12. Recovery of gold from a solution containing 1 ppm [AuCl₄]⁻, 1000 ppm Fe(III) and 0.1 M HCl by a reduced PPy/PTS membrane.

FIG. 13. Recovery of gold from solutions containing 50 ppm AuCN and 255 ppm NaCN by different polymer modified RVC. All experiments were performed for 20 h.

FIG. 14. Recovery of gold from a solution containing 70 ppm AuCN and 255 ppm NaCN by different polymer modified RVC, and activated carbon.

FIG. 15. Recovery of gold cyanide and copper cyanide from solutions containing 67 ppm AuCN, 41 ppm CuCN and 255 ppm NaCN, by different polymer modified RVC.

FIG. 16. Recovery of gold from solutions containing 0.1 ppm AuCN by different polymer modified RVC, and activated carbon.

FIG. 17. Removal of gold chloride from solution using a polypyrrole coated fabric. Solutions contained 0.1 M HCl and 100 ppm AuCl₄⁻.

PPy/Lycra 1: Lycra was coated for 6 hours.
PPy/Lycra 2: Lycra was coated for 12 hours.
Polymer coated lycra size: 2×15 cm.

FIG. 18. Scanning electron micrograph of the lycra after exposure to a solution containing 1000 ppm AuCl₄⁻ for 24 hours.

FIG. 19. Recovery of gold by polymer coated fabric from solutions containing 0.1 M HCl and 1 ppm AuCl₄⁻.

PPy/Lycra 1: Lycra was coated for 6 hours.
PPy/Lycra 2: Lycra was coated for 12 hours.
Polymer coated lycra size: 2×15 cm.

FIG. 20. Recovery of gold from a solution containing 70 ppm Au(CN)₂⁻ and 255 ppm NaCN by polymer coated fabric.

PPy/Lycra 1: Lycra was coated for 6 hours.
PPy/Lycra 2: Lycra was coated for 12 hours.
Polymer coated lycra size: 2×15 cm.

FIG. 21. Recovery of gold cyanide and copper cyanide from solutions containing 67 ppm Au(CN)₂⁻, 41 ppm Cu(CN)₂⁻ and 255 ppm NaCN, by polymer coated lycra.

PPy/Lycra 1: Lycra was coated for 6 hours.
PPy/Lycra 2: Lycra was coated for 12 hours.
Polymer coated lycra size: 2×15 cm.

### BEST MODE FOR CARRYING OUT THE INVENTION

Reagents Used

Pyrrole was obtained from Fluka and distilled prior to use. Aniline, bithiophene and 3-methylthiophene were obtained from Aldrich. The sulfonated β-hydroxyether (S-PHE) was supplied from Dr. Wolfgang Wernet (Ciba-Geigy). All other reagents used were obtained from Aldrich and were of analytical reagent (AR) grade. Deionised Milli-Q water (18 MΩ·cm) was used to prepare all solutions. Solutions containing gold were prepared by serial dilution from a 1000 ppm standard supplied by Aldrich. Duocel® Reticulated Vitreous Carbon (RVC) was obtained from ERG Materials and Aerospace Corporation, Oakland, Calif., USA.

Preparation of Polymer Modified RVC Electrodes

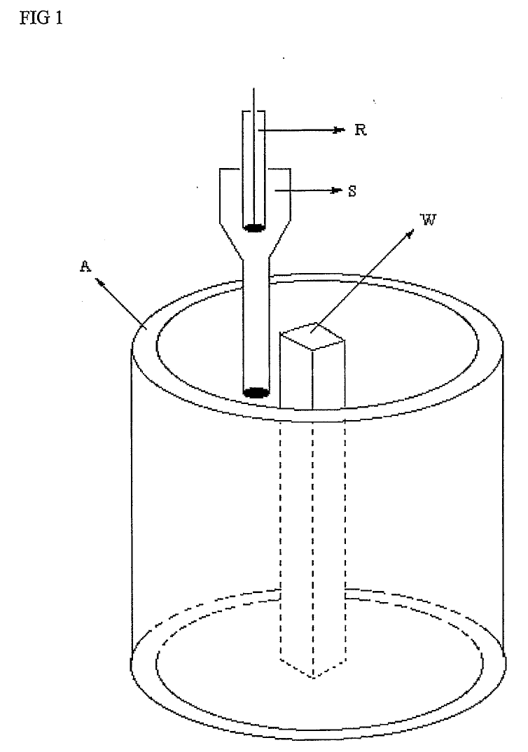

All polymerisations were carried out electrochemically using a three-electrode cell (FIG. 1). A large surface area RVC block (surface area of 65 cm²/cm³) was used as the working electrode, while another RVC cylinder was used as the auxiliary electrode. An Ag/AgCl (3 M NaCl_{(a,q)}) or Ag/Ag⁺ (3M tetrabutylammonium perchlorate in CH₃CN) reference electrode was used for experiments in aqueous solution and organic solvents, respectively. Polymerisations were carried out galvanostatically by applying a current density of 1.0 mA/cm² for 10 min. During this time a total charge of 39 000 mC/cm³ RVC was passed. For polymerisations performed with the same monomer and dopant, this resulted in the same amount of polymer being produced After polymerisation, the electrodes were washed thoroughly with distilled water, and stored in Milli Q water until required for further experiments. The conducting polymer layer produced was present in the oxidised state. In order to produce polymer modified RVC with the conducting polymer in the reduced state, a potential of −0.65 V was applied to the polymer, suspended in a 0.2 M NaCl solution, until the current decreased to 0 mA.

Polypyrrole Modified RVC Electrodes—PPy/Cl/RVC and PPy/PTS/RVC

RVC electrodes were soaked in concentrated nitric acid and ultrasonicated to remove all surface contamination. They were then rinsed with Milli Q water prior to use. Polymerisations were carried out in aqueous solution containing 0.2 M pyrrole, and either 0.5 M NaCl or 0.05 M PTS.

Polyaniline Modified RVC—PAn/Cl/RVC

RVC electrodes were soaked in concentrated nitric acid and ultrasonicated to remove all surface contamination. They were then rinsed with Milli Q water prior to use. Polymerisation was initiated in an aqueous solution containing 0.2 M aniline and 1 M HCl.

Poly(3-methylthiophene) Modified RVC Electrodes—PMT/ClO₄/RVC

RVC electrodes were soaked in acetonitrile and ultrasonicated to remove all surface contamination. They were then rinsed with acetonitrile prior to use. Polymerisation was initiated in an acetonitrile solution containing 0.2 M 3-methylthiophene and 0.1 M tetrabutylammonium perchlorate (TBAP).

Polybithiophene Modified RVC—PBT/S-PHE/RVC

RVC electrodes were soaked in propylene carbonate and ultrasonicated to remove all surface contamination. They were than rinsed with propylene carbonate prior to use. Polymerisations were initiated in a propylene carbonate solution containing 0.2 M bithiophene and 2% sulfated poly(β-hydroxyether). After polymerisation the polymer modified RVC was rinsed with propylene carbonate and dried in air, then washed with Milli Q water.

Preparation of Conducting Polymer Membranes (PPy/PTS, PBT/S-PHE) and Powders(PPy/Cl, PAn/Cl, PMT/ClO₄)

Polymerisations were carried out galvanostatically using a three-electrode cell, consisting of a RVC auxiliary electrode, an Ag/AgCl (3 M NaCl_{(aq)}) or Ag/Ag⁺ (3M TBAP in CH₃CN) reference electrode, and stainless steel plate (6 cm×8 cm) working electrode. The concentrations of monomer and supporting electrolyte used were the same as for the preparation of conducting polymer modified RVC. A constant current density of 1.0 mA/cm² was applied for 10 mins. After polymerisation was complete, the electrodes were washed thoroughly with distilled water.

Membranes composed of PPy/PTS or PBT/S-PHE were subsequently peeled off the stainless steel plate electrode. However, PAn/Cl, PMT/ClO₄ and PPy/Cl were obtained as powders that were scraped from the stainless steel plate electrode. Both powders and membranes contained the conducting polymer in the oxidised state. By subsequently immersing the membrane or powder in a 0.2 M NaCl solution, and applying a potential of −0.65 V until the current decreased to 0 mA, the conducting polymer was obtained in the reduced state.

Thermally sensitive polyelectrolytes, such as poly NiPAAM/AMP may be used as dopants. The structure is as follows:

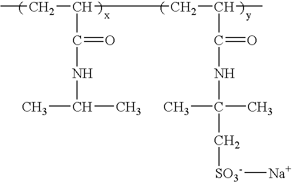

Such polyelectrolytes are thermally sensitive in that when the temperature is raised, the polyelectrolyte comes out of solution.

When a thermally sensitive polyelectrolyte is used as a dopant (A) in a conducting polymer, it induces similar behaviour providing a mechanism of recovery once gold is plated on the colloidal particle.

Recovery of [AuCl₄]⁻;

Polymer membranes, polymer powders and polymer modified RVC were added to 0.1 M HCl solutions containing varying concentrations of [AuCl₄]⁻ and, in some instances, iron. After allowing the recovery experiment to proceed for a pre-determined period of time, residual solution [AuCl₄]⁻ and Fe(III) were determined by AAS using a Varian SpectrAA Atomic Absorption Spectrometer. However, for experiments involving solutions with very low concentrations of [AuCl₄]⁻ (≦0.1 ppm), the gold that had deposited on the polymer modified RVC was instead determined. This was accomplished by neutron activation analysis (NAA) at Becquerel Laboratories, Lucas Heights, NSW, Australia.

Recovery of [Au(CN)₂]⁻.

All experiments involving recovery of [Au(CN)₂]⁻ were performed in the laboratories of Rio Tinto Technical Services, Bundoora, Melbourne, Australia. Polymer modified RVC to be used in [Au(CN)₂]⁻ recovery experiments was initially washed thoroughly with water, then residual water removed using tissue paper. The polymer modified RVC was then allowed to stand for a further 24 h. Solutions containing [Au(CN)₂]⁻ were prepared by first raising the pH of water to 10 using 10% NaOH, then adding NaCN to give the desired concentration of free cyanide, and finally adding AuCN with stirring until dissolution was complete. Recovery experiments were performed by adding 15 mL of this solution by syringe to a glass vial containing the polymer modified RVC, and shaking for 30 s. After allowing the recovery to proceed for a pre-determined period of time, aliquots were removed for gold analysis by AAS.

However, this approach is not restricted to the use of RVC as a substrate. The experiments described in detail below demonstrate that the use of a range of fabrics coated with polypyrrole is also a viable option for the recovery of precious metals such as gold.

The use of the fabric substrate may prove more useful in practical situations where the more brittle RVC substrate may be subject to fracture. The use of fabric substrates also provides other opportunities in placement, being more formable. Fabrics can for example be attached to the walls of pipes or other containers.

The use of nylon-lycra, cotton-lycra, cotton, polyester or wool are all envisaged to be examples of useful substrates. It is also envisaged that coated carbon cloths and fabrics would be particularly useful here.

It is also possible that other carbon coated materials such as activated carbon particles or fibres would prove useful as a substrate in this new gold recovery technology.

Instrumentation

UV-vis absorption spectra of PBT/S-PHE films grown onto Indium-Tin-Oxide (ITO) coated glass slides were obtained using a SHIMADZU Model UV-1601 spectrophotometer.

AFM and SEM micrographs were obtained using a Digital Multitude Nanoscope 3 and Leica Cambridge 440 Scanning Electron Microscope, respectively.
Recovery of Gold from Chloride Media

Interaction Between Metal Ion and Conducting Polymer in Acid Media

Addition of unmodified RVC to solutions containing varying concentrations of [AuCl₄]⁻ resulted in no change in appearance of either the solution or the RVC. AAS measurements confirmed that even after prolonged exposure no uptake of gold took place. By contrast, exposure of conducting polymer coated RVC to solutions containing [AuCl₄]⁻ usually resulted in rapid and extensive deposition of a gold-coloured deposit on the surface of the polymer. The process of electroless gold recovery by conducting polymers is believed to involve the formation of Au⁰ particles on the polymer surface. These form as a consequence of redox reactions between the polymer and Au(III) which also lead to the formation of overoxidised polypyrrole. Part of the thermodynamic driving force for these redox reactions is derived from the large positive potential for reduction of [AuCl₄]⁻ to Au⁰. Table 1 presents the polymers electrochemical redox potential in acid solutions and gold redox potential at polymer modified electrodes in acid solution. In each case the gold oxidation potential is ≧+0.98 V, indicating that [AuCl₄]⁻ is a strong oxidising agent.

TABLE 1
The electrochemical oxidation potential for polymer
and for gold at polymer modified electrodes.

| | Polymer oxidation | Au(III) oxdation potential |
|---|---|---|
| | Potential | at polymer modified electrode |
| Polymer | E(ox) (V) | (V) |
| PPy/Cl | −0.10 | 1.20 |
| PMT/ClO₄ | 0.90 | 1.30 |
| PAn/Cl | 0.50 | 0.98 |
| PBT/S-PHE | 1.02 | 1.12 |
| PPy/PTS | −0.08 | 1.03 |

* Determined by cyclic voltammetry of the polymers modified electrodes in 0.1 M HCl solutions and polymer modified electrodes in 0.01 M AuCl₄⁻ and 0.1 M HCl solution using a 3-electrode electrochemical cell consisting of a conducting polymer modified platinum working electrode, Ag/AgCl (3M NaCl_{(aq)}) reference electrode, and a platinum auxiliary electrode. Scan rate = 100 mV/s.

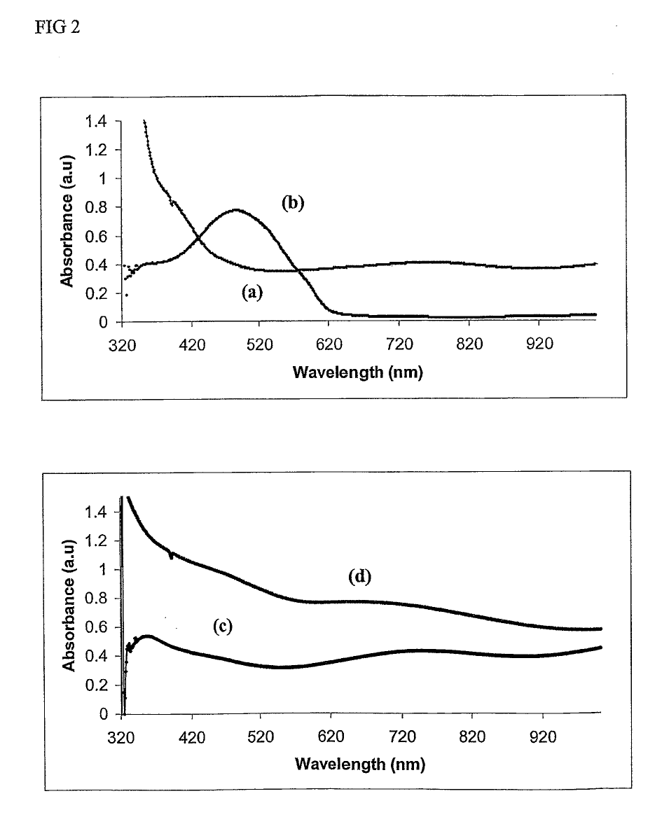

The formation of a layer of elemental gold on the surface of the conducting polymer is supported by changes in the UV-visible spectra and scanning electron micrographs of the surface of conducting polymer films after they had been exposed to gold. For example, FIG. 2 shows the UV-visible spectra of oxidized and reduced PBT/S-PHE films deposited onto ITO glass, before and after exposure to solutions containing [AuCl₄]⁻. It was found reduced PBT/S-PHE red film turns to green after immersion in Au³⁺ acid solution. The reduction of Au(III) to Au(0) results in the electroactive polymers attaining a higher oxidation state.

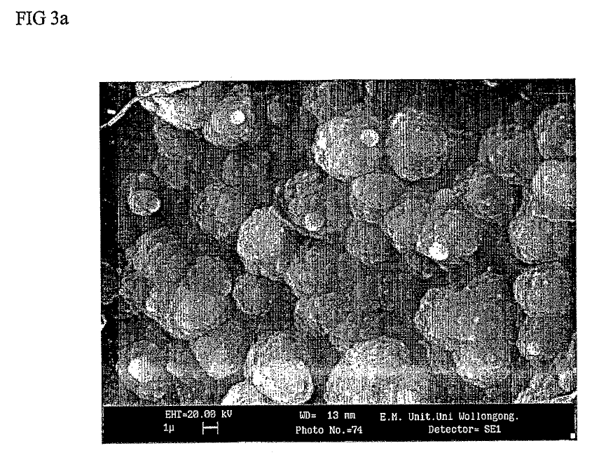

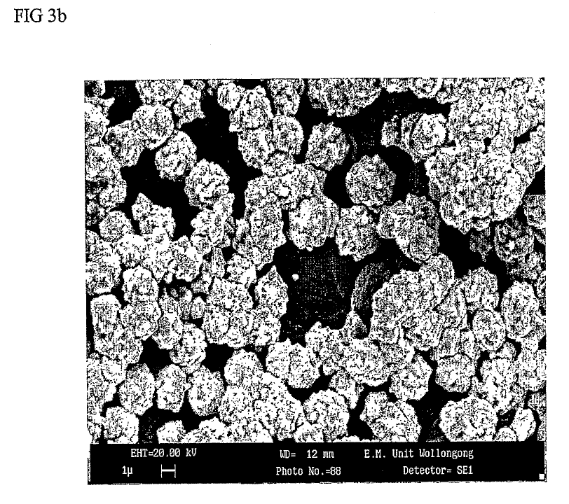

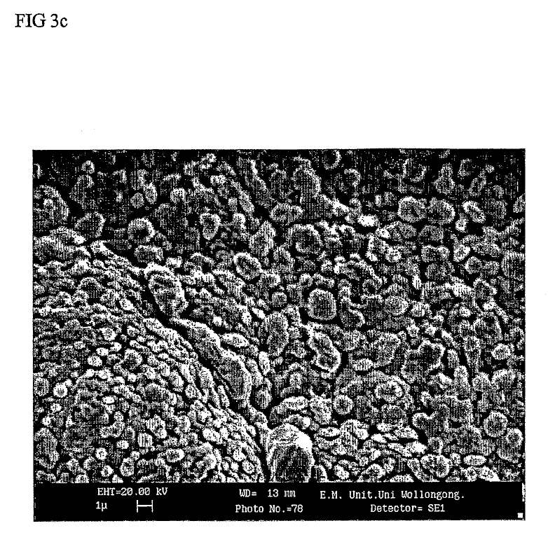

Further evidence for the formation of Au⁰ particles on polymer surfaces was provided by examining change in morphology observed after exposure to gold, using scanning electron microscope (SEM). FIG. 3 shows the surface morphology of an oxidized PPy/PTS membrane, before and after it had been exposed to a solution containing 4000 ppm [AuCl₄]⁻. Prior to exposure to the gold-containing solution, the SEM image of the surface (FIG. 3(a)) revealed that the PPy/PTS membrane had the “cauliflower” morphology typical of polypyrrole membranes [H. Zhao, W. E. Price, G. G. Wallace, J. Membr. Sci. 148 (1998) 161.]. However, after just 2 h exposure to the gold solution a second SEM micrograph of the surface of the polymer (FIG. 3(b)) showed that there was now a layer of crystalline gold metal deposited on the conducting polymer surface. On allowing the membrane to stand for even longer periods of time in the gold solution, the layer of gold metal became so thick as to almost totally obscure the underlying conducting polymer (FIG. 3(c)).

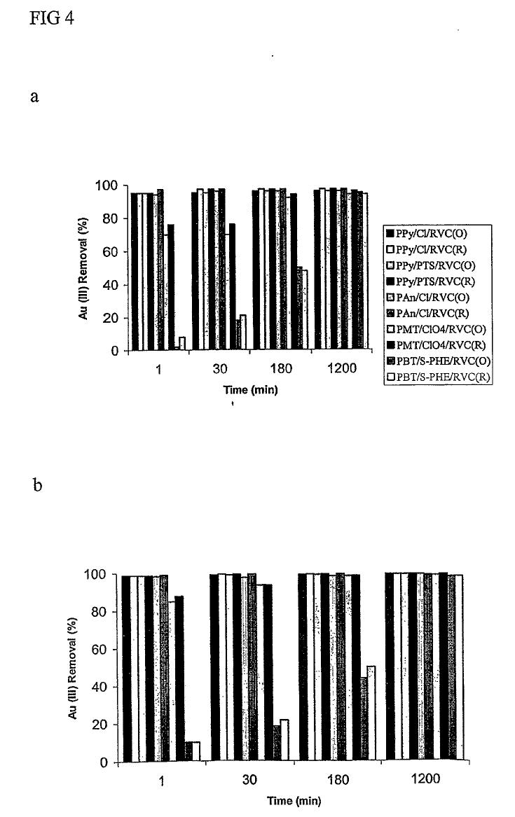

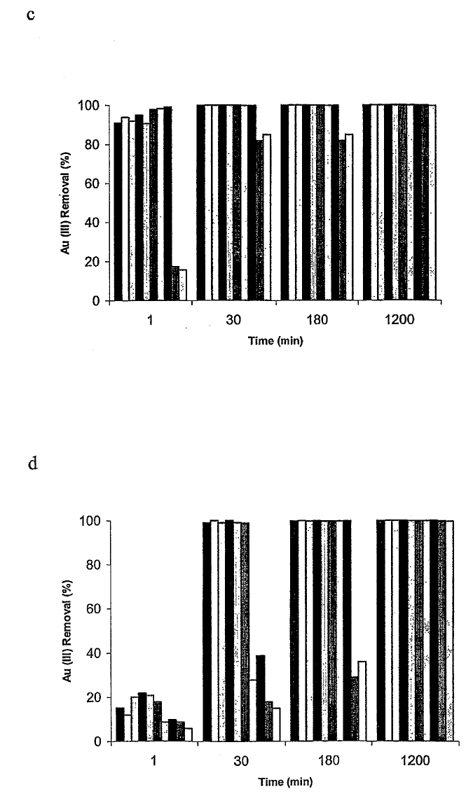

FIG. 4 illustrates the percent removal of [AuCl₄]⁻ from solutions with different initial concentrations, by different polymer modified RVC. When 1 ppm [AuCl₄]⁻ was used as the source solution, all polymers demonstrated ≧95% removal of gold (FIG. 4a). However, the rate with which the gold was recovered varied significantly. While the majority of the polymers examined showed ≧95% recovery after only 1 min exposure to the gold solution, significantly lower recoveries were displayed by both PMT/ClO₄ and, in particular, PBT/S-PHE. The latter polymer still displayed only a 50% recovery of gold after 3 h exposure.

Similar trends were observed when the experiments were repeated using either 5 ppm or 100 ppm [AuCl₄]⁻ solutions (FIG. 4b and 3.44c). Once again the kinetics of uptake was significantly slower for oxidised and reduced PBT/S-PHE/RVC than for the other polymers examined.

Increasing the concentration of [AuCl₄]⁻ in the source solution to 1000 ppm provided further insight into the relative rates of gold uptake for the different polymer modified RVC (FIG. 4d). For all polymer modified RVC's examined, ≦20% gold recovery was achieved after a 1 min exposure. However, after 30 min exposure ≧95% recovery was displayed by the oxidised and reduced forms of both PPy/Cl/RVC and PPy/PTS/RVC. Similar levels of recovery were only displayed by the remaining polymers after longer periods of exposure. It was found that the amount of gold uptake increased with increasing gold concentration, although the percentage of the gold removed from the parent solution decreased because of the higher gold concentration. The rate of precipitation increased with increasing gold concentration, as expected for a reaction controlled by the mass transport of gold chloride species to polymer surface.

The results presented in FIG. 4 illustrate that all of the different types of polymers examined display an inherent ability to remove significant quantities of gold from solutions containing [AuCl₄]⁻. It is also apparent that there is considerable variability in the rates of gold recovery by the different polymer modified RVC, but that these recovery rates are largely unaffected by the initial redox state of the polymer. In all experiments some polymeric material was detached from the RVC during uptake. This degradation was minimal, and was perhaps due to the presence of some overoxidised polymers which undergo hydrolysis reactions to form soluble products.

For electrochemical reactions those involving oxidation or reduction by electron transfer, reaction can be expressed in terms of electrode potentials. The free energy is related to the electrode potential by:

ΔG=−nFE

and if all species are in their standard states, then:

ΔG⁰=−nFE⁰

Where n is the number of electrodes transferred and F is the Faraday constant. E⁰ is values of standard electrode potential
The electrochemical reaction of the deposition of gold chloride onto polymer, e.g. PPy/Cl, which can be represented by two half-reaction:

Cathodic: AuCl₄⁻+3e⁻ [symbol] Au+4Cl⁻ E=1.20 V (Ag/AgCl)

Anodic: PPy⁺/Cl⁻+e⁻ [symbol] PPy⁰+Cl⁻ E=−0.10 V (Ag(AgCl)

For the overall redox reaction,

E_{cell}=E_{cathdic}−E_{anodic}

E_{cell}=1.20−(−0.10)=1.30 V

ΔG=−nFE=−3×96450×1.3=−376 kJmol⁻¹

The negative free energy change indicates that gold chloride deposition using PPy/Cl polymer is thermodynamically favorable. Table 2 shows the free energy change of electrochemical reactions between the other polymers and gold chloride. All AG values are negative, indicating that all reactions between the polymers and gold chloride are thermodynamically favorable, a fact readily confirmed by the experiments (FIG. 4).

TABLE 2
The free energy changed of redox reaction
between polymer and gold chloride.

| Polymer | Free energy change ΔG (kJmol⁻¹) |
|---|---|
| PPy/Cl | −376 |
| Pan/Cl | −138 |
| PMT/ClO₄ | −116 |
| PBT/S-PHE | −28.94 |
| PPy/PTS | −318 |

Gold Uptake Capacity

One of the most important properties for a conducting polymer to possess if it is to be used for gold extraction is high absorption capacity. Table 3 presents the maximum gold absorption capacity for several types of polymer modified RVC, as well as for some conducting polymer membranes. Capacities were obtained by exposing conducting polymer membranes or polymer modified RVC to a gold containing solutions until no further decrease in gold concentration was observed.

TABLE 3
Maximum gold absorption capacities for conducting polymer
membranes and conducting polymer modified RVC

| | Capacity |
|---|---|
| Polymer | (mg Au/g Polymer) |
| PPy/PTS/RVC* | 2941 |
| PPy/Cl/RVC* | 2732 |
| PAn/Cl/RVC* | 3142 |
| PMT/TBAP/RVC* | 2300 |
| PBT/S-PHE/RVC* | 1166 |
| PPy/PTS^{#} | 4945 |
| PPy/PTS* | 5089 |
| PBT/S-PHE^{#,†} | 1666 |
| PBT/S-PHE*^{,†} | 1832 |

*Polymer was in the reduced form.
^{#}Polymer was in the oxidised form.
^{†}Polymer broke up into many pieces during experiment.

Table 3 indicates that the maximum gold uptake capacities of the different types of polymer modified RVC and free standing membrane. The greatest capacity was displayed by PPy/PTS membranes, which could take up approximately five times their own weight in gold. For the two polymer membranes examined, no significant difference in capacity between the reduced and oxidised forms were noted. However, the capacities of both PPy/PTS membranes were approximately three times greater than that of oxidised or reduced PBT/S-PHE membranes. While there is no obvious explanation for this difference, it clearly indicates that differences in either or both the physical and chemical properties of polymer membranes can have a significant effect on gold uptake capacity. It was also noted that the large amounts of gold metal deposited onto PPy/PTS membranes were found to adversely affect their mechanical properties, making them extremely brittle and unable to be reused. The results also indicate that the capacity of the polymer free standing membranes are higher than the capacity of the polymer modified RVC, probably due to the fact that gold can be deposited on both sides of the membranes. Though polymer thin films show higher surface area, however, they are not ideal for real recovery processes. Practically, it is difficult to stack these films without folding them. RVC or fabrics provide high surface area substrates for polymer growth. Polymer coated RVC and fabrics can stand alone in solutions and occupies a relatively small space with a relatively large surface area.

According to the capacity of PPy/PTS 4945 mg Au/g polymer (oxidized polymer), 5089 mg Au/g polymer (reduced polymer), and the composition of per repeat unit (PPy)₃⁺ PTS⁻], the number of electrons lost during redox reactions can be predicted. The calculated results are 27 electrons lost/per repeat PPy/PTS unit for oxidised PPy/PTS and 28 electrons lost/per repeat PPy/PTS unit for reduced PPy/PTS during the redox reactions. The results indicate the capability of polymer deposition of metal is only slightly different between the oxidized and reduced polymer forms. The main contribution of polymer reduction is to ameliorate overoxidation of conducting polymer. Overoxidation results in dedoping of conducting polypyrrole and the formation of carboxyl group. PPy/PTS membranes had broken up after the redox reaction between PPy/PTS and Au(I). Compared to polypyrrole, polythiophenes undergo over-oxidation at significantly higher potentials. Polypyrroles generally undergo over-oxidation at potentials of around 0.70 V [J. Ding, W. E. Price, S. F. Ralph, G. G. Wallace, Synth. Met. 110, (2000) 123]. However, PBT/S-PHE was reported to over-oxidise only at approximately +1.35 V [T. W. Lewis, G. G. Wallace, G. Y. Kim, D. Y. Kim, Synth. Met. 84 (1997) 403].

It was found that PBT/S-PHE exhibited a higher oxidation potential after immersion in gold chloride solution, but was not able to reach the overoxidation potential of PPy/S-PHE. This clearly indicates that gold chloride is not able to over-oxidise the polybithiophene membrane. That can explain that the PBT/S-PHE membranes mechanical properties were not changed after soaking in gold chloride solution.

Recovery of Low Concentration Gold

While the above results clearly indicate the great propensity for polymer modified RVC or polymer modified fabric to extract gold from solutions containing [AuCl₄]⁻, it was still necessarily to demonstrate that the substrates of the present invention are able to recover gold from ores or solutions with very low gold contents. In order to examine whether polymer modified RVC or a polymer modified fabric is suitable for gold recovery under these conditions, an additional series of experiments were conducted. In each case the polymer modified RVC or activated carbon was exposed to the gold solution containing 0.1 ppm [AuCl₄]⁻ in 0.1 M HCl for 20 h. Owing to the reduced accuracy associated with measuring very small changes in gold concentration by AAS, gold recoveries were evaluated by determining the amount of gold deposited on the polymer modified RVC using neutron activation analysis (NAA). The NAA data show in Table 4.

TABLE 4
Recovery of Au (III) by polymers modified RVC from
low concentration gold chloride solutions.

| | Weight of | | | |
|---|---|---|---|---|
| | sample | | | |
| | (RVC + | NAA | Amount of | |
| | polymer) | result | gold at RVC | Au Removal |
| Polymer | (g) | (ppb) | (μg) | (%) * |
| PPy/PTS (O) | 0.363 | 4540 | 1.648 | 82.40 |
| PPy/PTS (R) | 0.398 | 5370.0 | 2.137 | 100.0 |
| PBT/S-PHE (O) | 0.399 | 5140.0 | 2.051 | 100.0 |
| PBT/S-PHE (R) | 0.361 | 4180.0 | 1.509 | 75.45 |
| PPY/Cl (O) | 0.301 | 5020.0 | 1.511 | 75.55 |
| PPy/Cl (R) | 0.284 | 4770.0 | 1.354 | 67.70 |
| PAn/Cl (O) | 0.415 | 2620.0 | 1.087 | 54.35 |
| PAn/Cl (R) | 0.433 | 2300.0 | 0.995 | 49.75 |
| PMT/ClO4 (O) | 0.294 | 3840.0 | 1.129 | 56.45 |
| PMT/ClO4 (R) | 0.361 | 4180.0 | 1.509 | 42.05 |
| Carbon | 0.100 | 2650 | 0.265 | 13.25 |

* Source solution: 20 mL of 0.1 ppm Au (III) in 0.1 M HCl.
(O) = polymer initially in the oxidized state.
(R) = polymer initially in the reduced state.

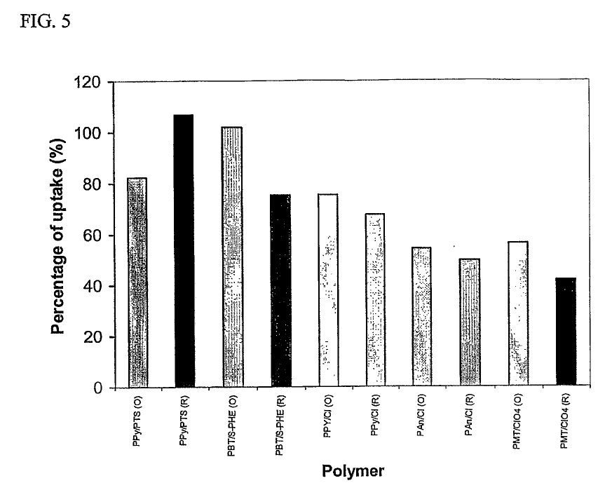

FIG. 5 illustrates the results of gold recovery by a range of polymer modified RVC and activated carbon base on Table 4. It was found that polymers were more effective in recovering low concentrations of gold than activated carbon. High gold recoveries were obtained using both PPy/PTS and PBT/S-PHE. In addition there was a small, but significant difference between the results obtained using the oxidised and reduced forms of the one polymer. While the calculated gold recoveries obtained using the other polymer modified RVC were slightly lower, this is in fact misleading. During the gold uptake process it was noticed that parts of these latter polymers and their associated gold deposits flaked off from the RVC, and were therefore not included in the amount of gold determined by neutron activation analysis. It is therefore probable that for all polymers examined recoveries above 80% were obtained. However, the superior mechanical properties of PPy/PTS and PBT/S-PHE when covered with gold particles potentially confer an advantage on these materials over the others examined. On the contrary, lower gold recovery was obtained using PPyCl/RVC, PAnCl/RVC and PMTClO₄/RVC, because of their very poor mechanical properties.

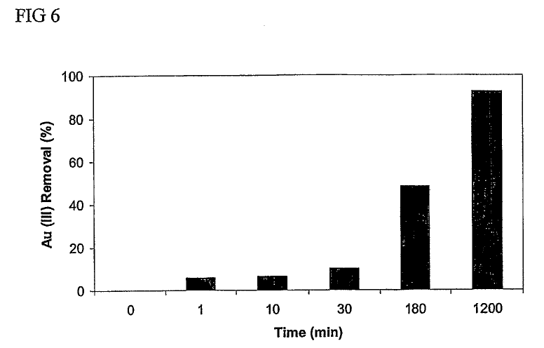

High recovery of Au(III) from low concentrations of gold solution was obtained using PPy/PTS modified RVC (PPy/PTS/RVC). In order to obtain further information concerning the kinetics of gold recovery at low gold concentrations, an additional experiment was performed using PPy/PTS/RVC. The results of this experiment are presented in FIG. 6. A small amount of gold recovery was observed during the first 30 min of exposure to PPy/PTS/RVC. After 3 h exposure only 50% of the gold present had been recovered. These results are not surprising for a reaction whose rate is probably controlled by the mass transport of [AuCl₄]- to the polymer surface.

Effect of Temperature and Polymer Thickness

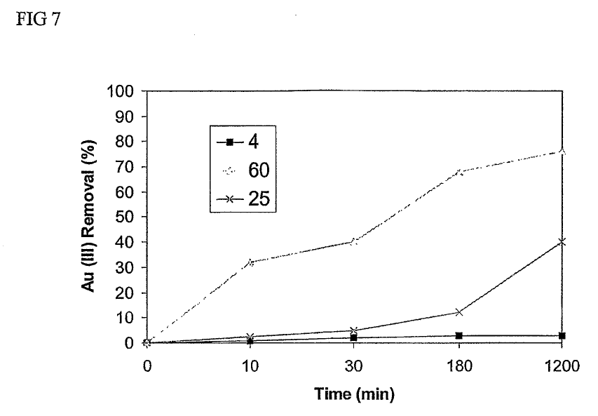

Among the variables likely to significantly influence the rate and yield of gold recovered, temperature and the thickness of the conducting polymer layer were considered to be two of the most important. The effect of temperature on the rate of deposition of gold metal from solutions containing 0.1 M HCl and 1000 ppm [AuCl₄]⁻ is illustrated in FIG. 7. The experiments were performed using oxidised PPy/PTS membranes measuring 2 cm×2 cm, and 50 mL of solution containing 0.1 M HCl and 1000 ppm [AuCl₄]⁻. FIG. 7 clearly shows that gold recovery is significantly enhanced at higher temperatures.

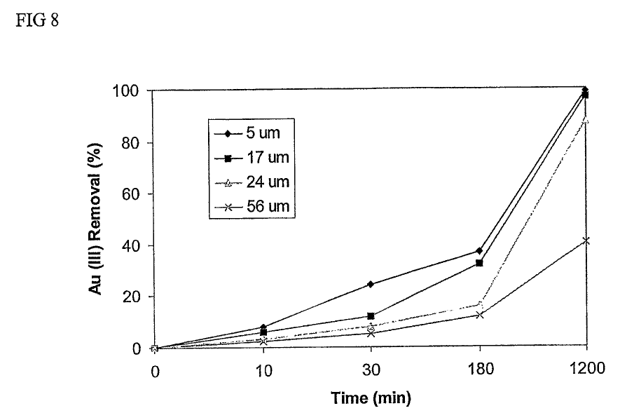

In order to investigate the effect of polymer membrane thickness on gold recovery, two experiments were performed using oxidised PPy/PTS membranes grown using a current density of 1 mA cm² for different periods of time. In the first experiment the membranes were added to 15 mL of solution containing 0.1 M HCl and 1000 [AuCl₄]⁻. The percent recovery of gold was monitored as a function of time, and is presented in FIG. 8. Overall it appears that while it was advantageous to grow the polymer for 20 min instead of 10 min, no further advantage in terms of the amount of gold recovered was obtained by growing membranes for longer periods of time.

In the second experiment an identical set of membranes (each 2×2 cm) were prepared and then added to 50 mL of solution containing 0.1 M HCl and 1000 ppm [AuCl₄]⁻. The concentration of gold in solution was monitored until no further changes were observed, and then the amount of gold recovered used to calculate the recoveries presented in Table 5. The capacity of the membranes was evaluated in two ways. It was found that the deposition capacity of gold increase with increasing the thickness of polymer, if that has been calculated by polymer surface area, however, the deposition capacity of gold decrease with increasing the thickness of polymer, if that has been calculated by polymer weight. This is possible because of the initial deposition of gold metal layer restrict access of gold solution to the polymer surface. In the extreme, the deposition of dense layer of gold deposition may result in anodic closure, completely stopping the reaction.

TABLE 5
The effect of polymer membrane thickness
on gold uptake capacity.

| | | Polymer | | Capacity | Capacity of |
|---|---|---|---|---|---|
| Growing | Charge | thick- | Polymer | of polymer | polymer |
| time | consumed | ness | weight | (mg Au⁰/g | (mg Au⁰/cm² |
| (minute) | (mC/cm²) | (μm) | (mg) | polymer) | polymer) |
| 10 | 600 | 5 | 2.7 | 5.92 | 3.85 |
| 20 | 1200 | 17 | 4.9 | 3.69 | 4.54 |
| 30 | 1800 | 24 | 7.8 | 3.01 | 5.87 |
| 45 | 2700 | 56 | 11.0 | 2.54 | 7.00 |

### Gold Uptake Using Polymer Coated Fabrics

### Experimental

Coating of fabrics was achieved by immersing a piece of fabric in an aqueous solution containing 0.015 M pyrrole monomer, 0.005 M NDSA and 0.04 M FeCl₃ for either 6 or 12 hours. The polypyrrole coated fabrics were taken out of solution and subsequently washed with copious amounts of water and then dried at room temperature.

Recovery of Gold from Chloride Media

It was found that polypyrrole coated lycra was highly effective in removing AuCl₄⁻ from solution (Figure F1). After 30 minutes approximately 50% was removed from a 100 ppm solution and almost complete removal was obtained within 20 hours. SEMs (Figure F2) showed that the gold is recovered as gold metal particles as observed previously for PPy/PTS membrane.

Interestingly nylon lycra itself extracts some 40% of the AuCl₄⁻ after 20 hours but not as metallic gold.

Even at low concentrations Figure F3), approximately 80% was removed from a 1 ppm solution after 30 minutes and almost complete removal was obtained within 3 hours.

The recovery of gold cyanide was also investigated using a 70 ppm solution (Figure F4). Again significant amounts of gold were removed even on short time scales (>80% after 30 minutes).

Again the uncoated lycra was found to remove a significant amount of Au(CN)₂⁻ from solution.

The removal of Au and Cu from cyanide solutions was then considered. Both metals were efficiently removed from solution with a selectivity factor of ≈2 in favour of gold at least with the more lightly coated fabrics. Compared with polymer coated RVC, fabrics show slightly higher selectivity for gold uptake.

Interestingly almost all of the Cu(CN)₂⁻ was removed by uncoated lycra after 20 hrs while only 20% of gold was removed (Figure F5).

### Gold Uptake Using Polymer Coated Carbon

### Experimental

An activated carbon particle was coated galvanostatically by applying a current density of 1.0 mA/cm² for 10 min in an aqueous solution containing 0.2 M pyrrole and 0.05 M pTS. A 0.021 g carbon particle (bulk density 0.5 g/cm³) was used as the working electrode, with an RVC cylinder auxiliary electrode. A Ag/AgCl reference electrode was used.

Results

TABLE 6
Recovery of Au by polymer coated carbon

| | | Concentration | Concentration | Au |
|---|---|---|---|---|
| Poly- | Weight of | Before uptake | After uptake | Removal |
| mer | carbon (g) | ppm | ppm | (%) * |
| PPy/ | 0.021 | 100 | 0.1 | 99.9 |
| PTS/ | | | | |
| carbon | | | | |

* The polymer coated carbon was exposed to gold solution containing 100 ppm AuCl₄⁻ in 0.1 M HCl for 20 h.

Recovery of [AuCl₄]⁻ from Solutions Containing Excess Iron

Leachates derived from gold-bearing ores, and industrial process streams usually contain a variety of metal ions and complexes in addition to gold and gold complexes Table 7 shows the composition of an industrial solution produced by the Lihir mine in Papua, New Guinea. In addition to the considerable amounts of alkali metal and alkaline earth metal ions present, there are also significantly greater quantities of iron compared to gold. It is therefore apparent that new gold recovery techniques should be capable of removing the precious metal selectively in the presence of much greater quantities of iron.

TABLE 7
Composition of an industrial process solution
from the Lihir gold mine, Papua, New Guinea.*

| Component | Concentration (ppm) |
|---|---|
| Au | 0.005 to 0.020 |
| H₂SO₄ | 500-5000 |
| Cl | 9000-17000 |
| Cu | 10 |
| Total Fe | 3000-5000 |
| Zn | 10 |
| Pb | <0.05 |
| Mg | 500 |
| K | 10-20 |
| Na | 4000-7000 |
| Ca | 700 |
| As | 80 |
| Total S | 6000 |

*pH = 0.5-1.0

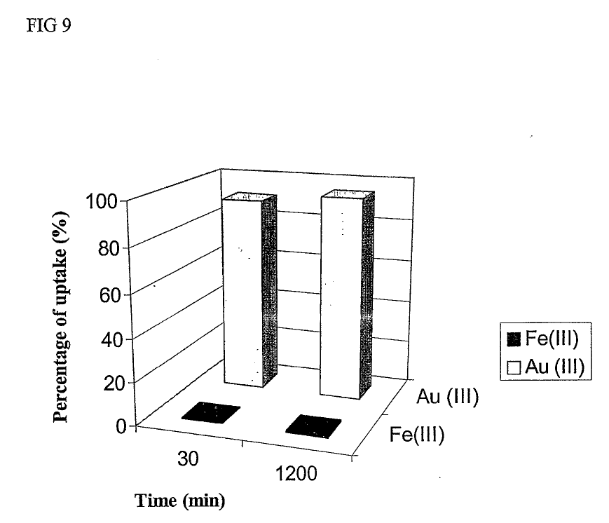

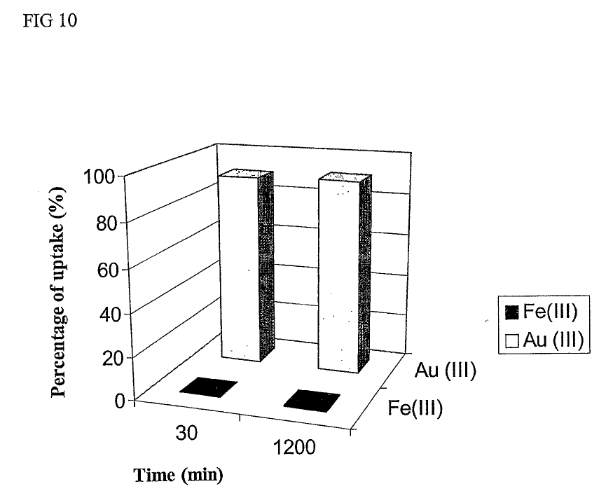

FIGS. 9 and 10 show the results of gold uptake experiments performed using PPy/PTS/RVC or PMT/ClO₄/RVC. The figures illustrate results obtained from experiments performed with the polymer in the oxidized state. Essentially identical results were obtained when the polymer was present in its reduced state In each case the polymer modified RVC was exposed to a 0.1 M HCl solution containing 1 ppm [AuCl₄]⁻ and 1000 ppm Fe(III).

Both figures clearly illustrate the selective nature of the gold uptake process. Even in the presence of a 1000 fold excess of Fe(III), after 20 h there was essentially no change in iron concentration, while approximately 90% of the gold present was deposited onto the polymer. While still an extremely high recovery rate, this still represents a small decrease in gold recovery compared to the experiments performed using solutions containing 1 ppm [AuCl₄]⁻ and no iron. No significant difference in overall extraction efficiency was noted between the two types of polymer modified RVC examined. Furthermore for both types of polymer modified RVC gold recovery was facile. There was essentially no difference in the amounts of either gold or iron recovered after 30 min and 1200 min for either system. However, when a PPy/PTS/RVC or free standing PPy/PTS membrane was immersed in to the Fe(III) solution, the solution changed colour after one second, indicating that Fe(III) was reduced to Fe(II) by the polymer.

The energy changed during the reaction also can indicate the possibility of reaction. The electrochemical reaction between Fe³⁺ and polymer, e.g. PPyPTS, which can be represented by two half-reaction:

Cathodic:

Fe³⁺+e⁻ [symbol] Fe²⁺ E=0.771 V

Anodic:

PPy⁺/PTS⁻+e⁻+A⁺ [symbol] PPy⁰/PTS⁻A⁺ E=0.10 V (Ag/Ag/Cl)

E⁰≈0.10 V+0.222 V≈0.322 V

For the overall redox reaction,

E_{cell}=E_{cathodic}−E_{anodic}

E_{cell}=0.771−0.322=0.449 V

ΔG=−nFE⁰=−1×96450×0.449−43.3 kJmol⁻¹

The negative free energy change indicates that Fe(II) reduced to Fe(II) by PPy/PTS are thermodynamically favorable.
The electrochemical reaction between Fe²⁺ and polymer, e.g. PPyPTS, which can be represented by two half-reaction:

Cathodic:

Fe²⁺+2e⁻ [symbol] Fe B⁰=−0.440 V

Anodic:

PPy⁺/PTS⁻+e⁻+A⁺ [symbol] PPy⁰/PTS⁻A⁺ E=0.10 V (Ag/Ag/Cl)

E⁰≈0.10 V+0.222V≈0.322V

For the overall redox reaction,

E_{cell}=E_{cathodic}−E_{anodic}

E_{cell}=−0.440−0.322=−0.762 V

ΔG⁰=−nFE⁰=−2×96450×(−0.762)=147 kJmol⁻¹

The positive free energy change indicates that iron chloride deposition using PPy/PTS are not thermodynamically favorable.

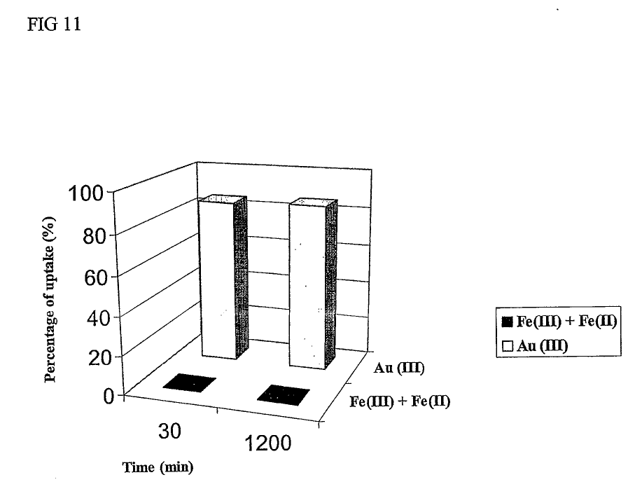

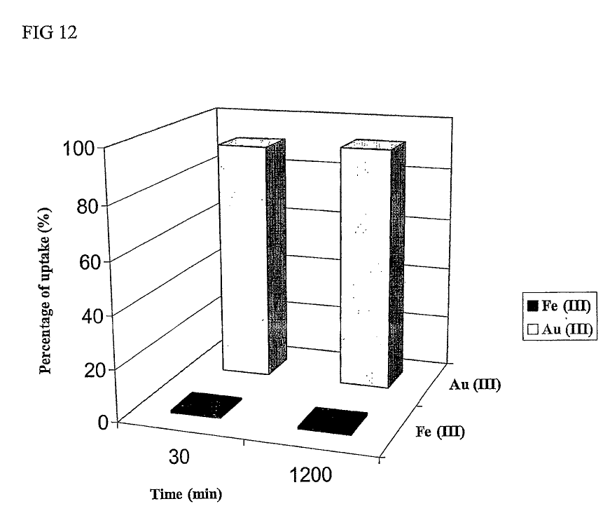

Almost identical results were obtained when the experiment was repeated using RVC coated with reduced PPy/PTS, and a 0.1 M HCl solution containing 1 ppm [AuCl₄]⁻, 3000 ppm Fe(II) and 3000 ppm Fe(III) (FIG. 11). In addition, the rate and extent of gold recovery observed when membranes composed of reduced PPy/PTS were exposed to 0.1 M HCl solutions containing 1 ppm [AuCl₄]⁻, and 1000 ppm Fe(III) (FIG. 12), was essentially identical to that obtained using PPy/PTS/RVC. Comparable results were also obtained when oxidised PPy/PTS membranes were used. Overall the results of experiments involving conducting polymer membranes indicate that RVC has little influence on either the selectivity or kinetics of gold uptake from solutions containing mixtures of gold and iron.

The great selectivity of the extraction process observed in these experiments stems from the differences in oxidising properties between Au(III), Fe(III) and Fe(II). The standard reduction potentials for these 3 metal ions are:

AuCl₄⁻+3e⁻ [symbol] Au⁰ E⁰=1.20 V

Fe³⁺+e⁻ [symbol] Fe²⁺ E⁰=0.771 V

Fe²⁺+2e⁻ [symbol] Fe E⁰=−0.440 V

Of the three metal ions only Au(III) is capable of over-oxidising polypyrrole, and in so doing it is reduced to the elemental metal. Further evidence for the lack of reactivity of iron towards conducting polymers was provided by Scanning Electron Microscopy. Micrographs of the surfaces of PPy/PTS membranes which had been exposed to solutions containing high concentrations of Fe(III) were identical to those of membranes which had not been exposed to any iron, and showed no evidence for deposition of metallic iron.

Additional experiments examining the effect of Fe(III) and Fe(II) on gold uptake capacity were performed using oxidised and reduced PPy/PTS membranes (2×2 cm). One set of experiments was performed using 50 ml of solution containing 1000 ppm [AuCl₄]⁻, 3000 ppm Fe(II) and 0.1 HCl, while a second set of experiments was performed using 50 ml of solution containing 1000 ppm [AuC₄]⁻, 3000 ppm Fe(III) and 0.1 M HCl. It was found that after either membrane was soaked in a solution containing [AuCl₄]⁻ and Fe(II) no gold deposition had occurred on the membrane surface. Instead particles of gold deposited on the bottom of the beaker as a result of the following reaction:

Au³⁺+3Fe²⁺ [symbol] Au⁰+3Fe³⁺

This was confirmed by repeating the reaction in the absence of the polymer modified RVC. By contrast when either type of membrane was soaked in the solution containing [AuCl₄]⁻ and Fe(III), gold deposited on the membrane surface. The uptake capacity of the reduced PPy/PTS membrane was 3480 mg Au⁰/g polymer, while that for the oxidised PPy/PTS membrane was 2950 mg Au⁰/g polymer. Both results are significantly lower than the uptake capacity obtained using a solution containing only gold. This is because of the process consists in reduction of Au(III) to Au(0) with simultaneous reduction of Fe(III) to Fe(II).

Recovery of Other Metals Using Conducting Polymers

Tables 8 and 9 summarize the results of recovery experiments involving a variety of metal ions and both PPy/PTS and PBT/S-PHE membranes. In both sets of experiments evidence for metal deposition on the conducting polymer was sought by checking for changes in polymer conductivity and surface morphology. Of all the metals examined only silver was found to be recovered to a significant extent, and then only when the polymer was PPy/PTS. If the mechanism of silver recovery involves reduction of the metal ion by the polymer, it is also possible to rationalize the lack of a silver deposit when PBT/S-PHE membranes were used. The Ag(I)/Ag(0) redox couple occurs at an intermediate potential with respect to both PPy/S-PHE and PPy/PTS, with only the latter polymer a sufficiently strong reductant to be able to reduce Ag(I) to Ag(0). Consequently, the metal ions selectivity can be achieved by choosing polymer with different E⁰ values. The condition of metal ions deposition is required as metal oxidation potential is higher than polymer oxidation potential or polymer is more active than metal. However, some metal ions were reduced by polymers, but not deposited on polymer surface, e.g. Fe³⁺. PPy/PTS, PBT/S-PHE, PMT/TBAP and PAn/Cl have also been examined in Mn^{7+, Cr}⁷⁺ containing solutions, where these metal ions exist a higher valence. The solutions changed color, the purple of Mn₇₊ or the yellow of Cr⁷⁺ have disappeared and both can be reduced to lower valence metals ions Mn⁴⁺ and Cr⁴⁺ by polymers.

The general reaction between polymer and metal ions is assumed to proceed according to:

(PPy⁺/A⁻)ₙ+n′M^{+α}→(PPy⁺/A⁻)ₙ^{+β}+n′M^{+α-β}

α is metal ion valence. β is the number of lost or gain electrons during redox reaction between polymer and metal ion.
or

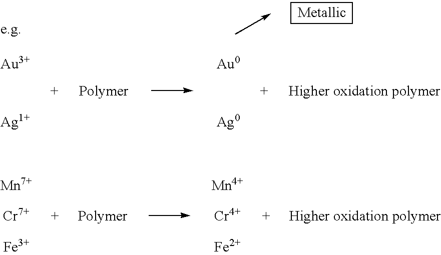

TABLE 8
Metal ion recovery experiments performed using solutions
containing 0.01 M metal ion and PPy/PTS membranes.*

| | | Change in | |
|---|---|---|---|
| | Change in | mechanical | |
| | conductivity of | properties of | Metal deposition on |
| Metal ion | polymer | polymer | polymer surface |
| Au³⁺ | Yes | Very brittle | Thick Au⁰ deposit |
| Cu²⁺ | No | No | No |
| Fe³⁺ | No | No | No |
| Zn²⁺ | No | No | No |
| Mg²⁺ | No | No | No |
| Mn²⁺ | No | No | No |
| Ni²⁺ | No | No | No |
| Co²⁺ | No | No | No |
| Gd³⁺ | No | No | No |
| Ag⁺ | No | Yes | Ag⁰ deposition |
| Pb²⁺ | No | No | No |

*All experiments performed for 20 hours.

TABLE 9
Metal ion recovery experiments performed using solutions
containing 0.01 M metal ion and PBT/S-PHE membranes.*

| | | Change in | |
|---|---|---|---|
| | Change in | mechanical | |
| | conductivity of | properties of | Metal deposition on |
| Metal ion | polymer | polymer | polymer surface |
| Au³⁺ | Yes | No | Thick Au⁰ deposit |
| Cu²⁺ | No | No | No |
| Fe³⁺ | No | No | No |
| Zn²⁺ | No | No | No |
| Mg²⁺ | No | No | No |
| Mn²⁺ | No | No | No |
| Ni²⁺ | No | No | No |
| Co²⁺ | No | No | No |
| Gd³⁺ | No | No | No |
| Ag⁺ | No | Yes | No |
| Pb²⁺ | No | No | No |

*All experiments performed for 20 hours.

Recovery of Gold from Cyanide Media

The previous studies indicated that conducting polymer membranes and polymer modified RVC are very effective at recovering gold from aqueous solutions containing [AuCl₄]⁻. However, most industrial solutions or mineral leachates contain the cyanide complex [Au(CN)₂]⁻. The reduction potential for this complex is considerably lower than that for [AuCl₄]⁻, as shown below:

AuCl₄⁻+3e⁻ [symbol] Au⁰ E⁰=1.20 V

2Au(CN)₂⁻+2e⁻ [symbol] 2Au+4CN⁻ E⁰=−0.67 V

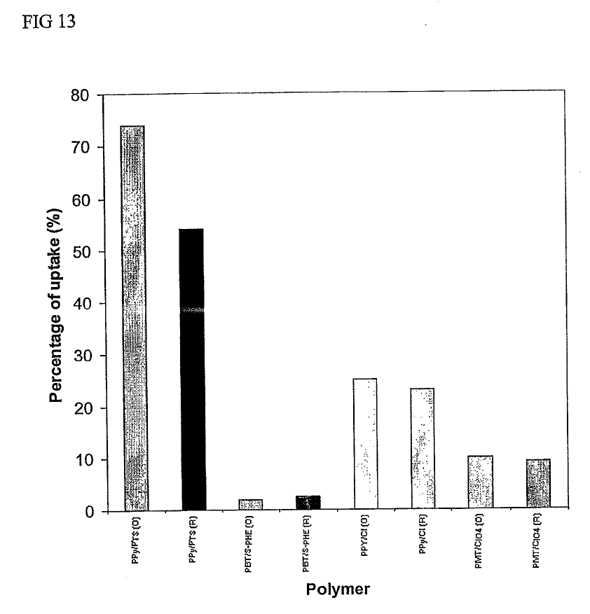

It is therefore unlikely that conducting polymer membranes or polymer modified RVC could remove [Au(CN)₂]⁻ from solutions by a redox mechanism. However, the possibility remains that the intact complex could be recovered by either adsorption, or through an ion-exchange mechanism in which the gold cyanide complex replaces the dopant in the conducting polymer. In order to investigate this possibility a series of experiments were conducted in which the oxidised and reduced forms of several types of polymer modified RVC were exposed to a solution containing 50 ppm [Au(CN)₂]⁻ and 255 ppm NaCN. The results of these experiments are presented in FIG. 13. Of the conducting polymer modified RVC examined, only those containing PPy/PTS showed significant gold recovery. When the polymer was present in the oxidised state an overall recovery of 73% was obtained, compared to 54% when the polymer was present in its reduced state. Neither polymer modified RVC displayed a yellow colouring, indicating that the mechanism of recovery does not involve a redox reaction leading to gold metal.

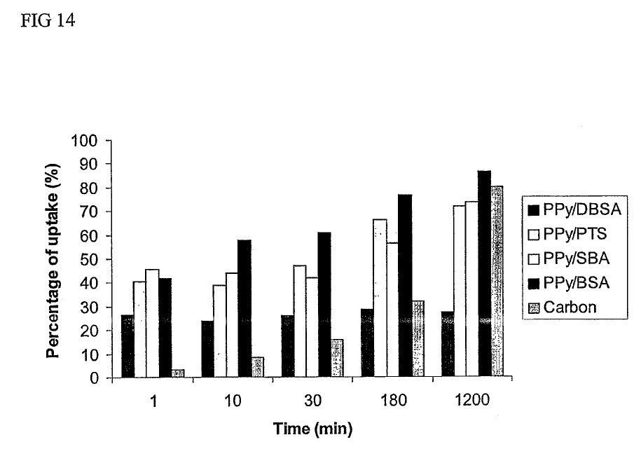

In order to shed further light on which types of polymer modified RVC lead to significant recovery of [Au(CN)₂]⁻, an additional series of experiments was conducted under similar conditions using several other conducting polymers containing dopants with similar structures to PTS. The dopants examined were para-toluenesulfonic acid (PTS), dodecylbenzenesulfonic acid (DBS), benzenesulfonic acid (BSA) and sulfobenzoic acid (SBA). The amounts of gold recovered were determined at several time points over a period of 20 h, and are presented in FIG. 14. Only the oxidised forms of the polymer modified RVC were examined, since the oxidised form of PPy/TS modified RVC showed greater gold recovery. Also included in FIG. 14 are results obtained for a mass of activated carbon (100 mg) that was equivalent to the mass of polymer deposited onto RVC in each case.

FIG. 14 illustrates that each of the conducting polymer modified RVC examined were capable of recovering significant amounts of gold from solution. In none of the experiments were any yellow coatings noted on the polymer modified RVC, consistent with the absence of metallic gold. After just one minute exposure each conducting polymer modified RVC had removed between 20 and 45% of the gold present in solution, compared with <5% gold recovery using activated carbon. On standing for longer periods of time the amount of gold recovered using PPy/DBSA/RVC did not appear to increase significantly. However, the amounts of gold recovered using each of the other types of polymer modified RVC, or activated carbon, did improve significantly with time. After 20 h exposure no further significant amounts of gold recovery were observed. At this stage PPy/PTS/RVC, PPy/BSA/RVC and PPy/SBA/RVC gave gold recoveries between 75 and 85%, comparable to the value of 80% achieved using activated carbon. While the overall gold extraction efficiencies of the three types of polymer modified RVC were very similar to that of activated carbon, FIG. 14 clearly illustrates that the former materials displayed a significant advantage in terms of the rate of gold recovery. For the three polymer modified RVC, gold recoveries of ≧60% were obtained after just 3 h exposure. These values are comparable to the values obtained after 20 h exposure for the same material. However, they are almost twice as great as the value of 35% obtained after 3 h exposure to activated carbon.

The above results provided further encouragement to explore the potential for using conducting polymer modified RVC to recover gold from cyanide leachates. One question that needed to be answered was whether the polymer coated RVC could recover gold from a typical cyanide leachate, which contains many other species in addition to [Au(CN)₂]. This is especially pertinent since the mechanism of gold recovery is unlikely to involve redox chemistry, which provided the basis for the selectivity seen in acidic chloride solutions. Table 10 gives the composition of a typical cyanide leachate, from the Peak gold mine in New South Wales. It is clear from Table 10 that one of the most important interferents in cyanide leachates will be [Cu(CN)₂]⁻.

TABLE 10
Composition of a cyanide leachate obtained
from the Peak gold mine, NSW Australia.*

| Component | Concentration (ppm) |
|---|---|
| Au | 0.1-0.2 |
| Cu | 110 |
| Fe | 0.40 |
| Zn | 1-30 |
| Pb | 0.1-1.0 |
| Mg | 40 |
| Ag | <0.02 |
| K | 140 |
| Na | 1200-1400 |
| Ca | 120-250 |
| Cd | <0.034 |
| Mn | 0.5 |
| As | 0.0001 |
| Ni | 0.0001 |
| Total Dissolved salts | 4000-5000 |
| S₂⁻ | 20 |
| NO₃⁻ | 130 |
| SO₄²⁻ | 1600-2100 |
| Cl | 500-700 |
| Total CN | 80-100 |
| WAD Cyanide | 80-100 |
| Free cyanide | <0.1 |
| SCN⁻ | 300-500 |

*pH 8.5

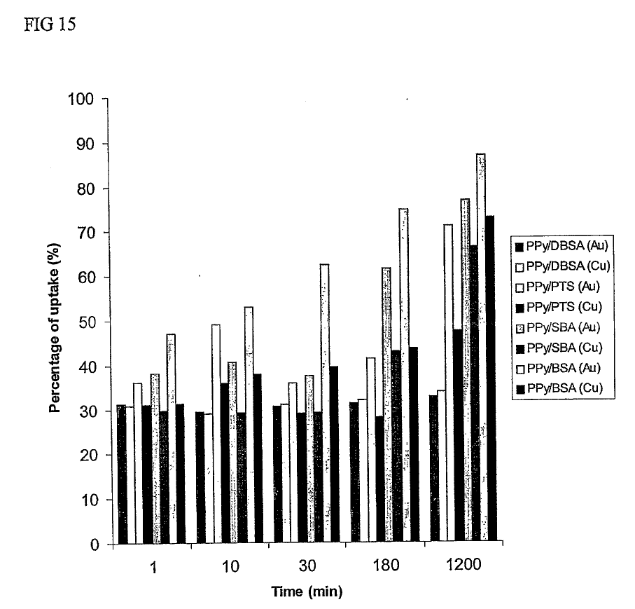

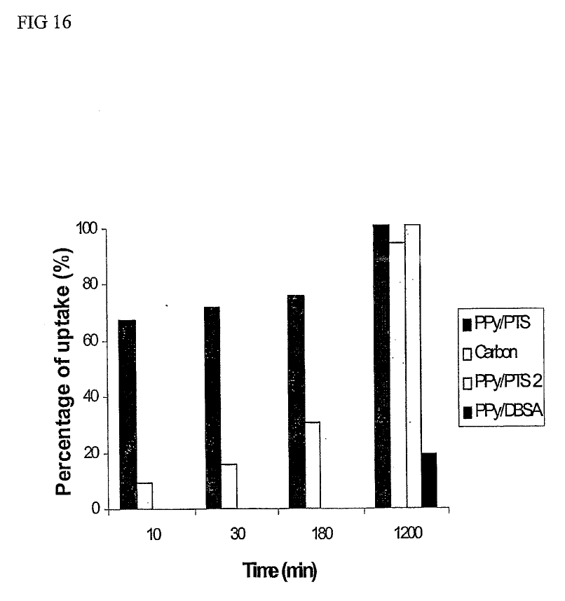

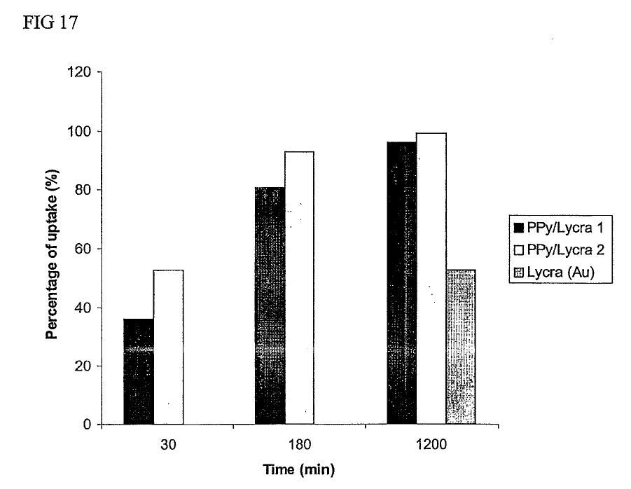

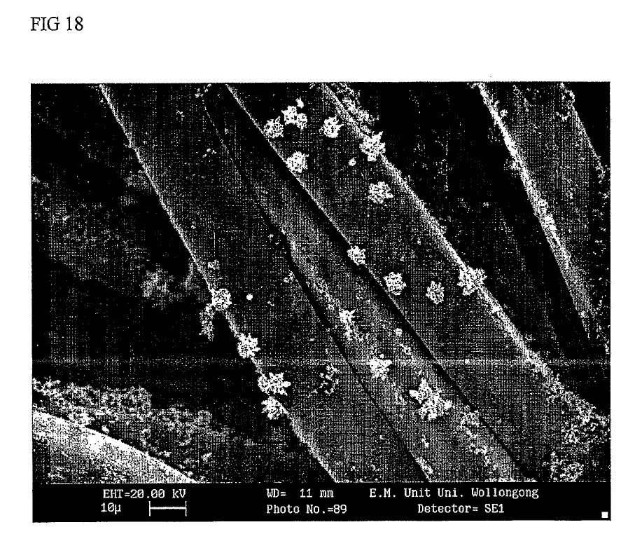

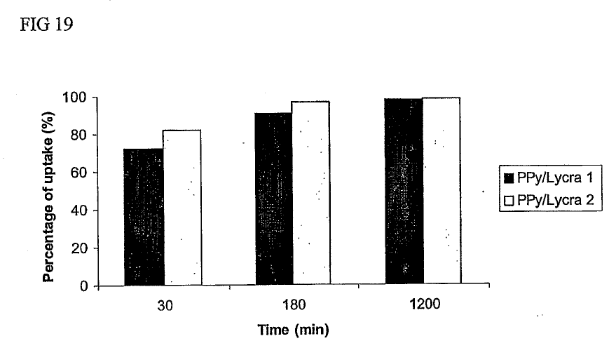

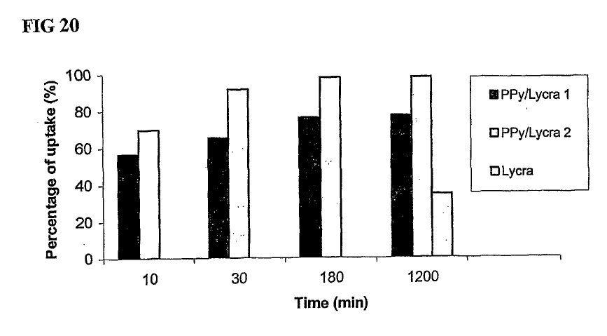

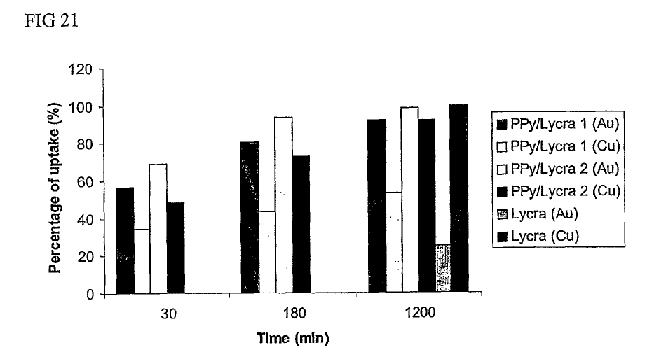

FIG. 15 shows the amounts of [Au(CN)₂]⁻ and [Cu(CN)₂]⁻ recovered by different polymer modified RVC from a solution containing both cyanide complexes as well as free cyanide. Both anionic complexes were recovered to a significant extent by each of the four types of oxidized polymer modified RVC examined. However, it is noteworthy that very little additional uptake of either complex occurred after the first minute of exposure, when PPy/DBSA modified RVC was used. This result is consistent with what was observed in earlier experiments with this material, and suggests that capacity may be significantly less than that of the other three polymer modified RVC examined. For these latter materials the final amounts of gold recovered ranged from 70-85%, with PPy/BSA/RVC displaying the greatest gold uptake, and PPy/PTS/RVC the least. While the amounts of copper recovered by these three materials was slightly less than the amounts of gold, the same trend in copper uptake amongst the three materials was observed. This is consistent with either an adsorption or ion-exchange mechanism of metal ion uptake, both of which would be unlikely to show a strong dependence on the chemical identity of the species being recovered. Since Table 9 indicates the concentration of [Au(CN)₂]⁻ present in a typical industrial leachate is likely to be considerably less than that used in the previous experiments, an additional experiment was performed to examine the ability of polymer modified RVC to recover gold from solutions containing [Au(CN)₂]⁻ at low concentrations. FIG. 16 illustrates the results obtained using a 0.1 ppm solution of [Au(CN)₂]⁻ for the oxidized forms of three different polymer modified RVC, as well as for activated carbon. Consistent with the above results, PPy/DBSA/RVC recovered significantly smaller quantities of gold, and in a less facile manner, than any of the other materials examined. After 20 hours exposure to the gold solution, PPy/PTS/RVC had recovered essentially all gold from the solution, compared to a 90% recovery exhibited by activated carbon. However, what was perhaps more significant was the greater speed with which the conducting polymer modified RVC recovered gold from solution. For example, after only 10 min exposure PPy/PTS/RVC had recovered 65% of gold from the solution, compared to only 10% when activated carbon was used.

### CONCLUSION

A range of conducting polymers including polypyrroles, polyanilines and polythiophenes with different reduction potentials were trialed and found to be successful. Conducting polymer modified RVC (Reticulated Vitreous Carbon), conducting polymer free standing membranes, conducting powders, coated fabrics and colloidal dispersions were all used. It was found that high recovery of gold from acidic solutions proceeded in a facile manner over a wide range of gold concentrations. Without wishing to be bound by theory, the high capacity of the new material is due largely to the high surface area to volume ratio of the support substrates identified. High selectivity for particular metal ions can be obtained by the choice of appropriate polymer. In each case a deposition process is believed to occur which leads to the formation of a metallic gold layer on the polymer/RVC surface and according to:

[(P)ₘ⁺/A⁻]ₙ+⅓βAu³⁺ [symbol] (P)ₘ⁺/A⁻]ₙ^{+β}+⅓βAu⁰

Where β is the number of electrons lost during redox reaction between polymer and gold ions.

The process of electroless deposition of gold as solid polymer films may be regarded as beginning with a nucleating step resulting in Au⁰ particles that are formed on the polymer surface due to redox reactions between the polymer and gold(III). The deposition of gold chloride onto conducting polymers is dependent upon many chemical and physical factors which affect both the deposition kinetics and the deposition capacity. The type of polymer, redox state, surface area, solution pH and temperature all had significant effects on the rate of gold uptake.

A range of conducting polymers modified RVC were also trialed in gold cyanide solution and found to be successful. The mechanism of the interaction between polymer and gold cyanide seems to be due to adsorptive ion exchange according to:

[(Py)ₘ⁺/A⁻]ₙ+nAu(CN)₂⁻ [symbol] [(Py)ₘ⁺/Au(CN)₂⁻]+ₙ+nA⁻

When compared the results obtained using polymer modified RVC with activated carbon under the same experimental conditions, it was found that some of the polymer modified RVC are more effective than carbon for gold cyanide removal. The gold uptake exhibited a strong dependence on the hydrophobic properties of polymers.

It will be appreciated by those skilled in the art that the invention as described herein may be embodied in many other alternative forms without deviating from the inventive concept disclosed.

The claims of the invention are as follows:

1. A method of separation and/or recovery of a precious metal from a solution containing said precious metal in ionic form, including the step of contacting a solution containing said precious metal in ionic form with a conducting polymer.

2. A method according to claim 1 wherein separation and/or recovery is by the precipitation of the precious metal.

3. A method according to claim 1 wherein the precious metal is gold (Au), platinum (Pt) or palladium (Pd).

4. A method according to claim 3 wherein the precious metal is gold recovered from an anionic gold species of the form [AuXₙ]^{q-}.

5. A method according to claim 4 wherein X is an anionic species, n is from 1 to 4 and q is from 1 to 3 and X is fluoride, bromide, iodide or chloride.

6. A method according to claim 4 wherein the anionic gold species is [Au(CN)₂]⁻.

7. A method according to claim 4 wherein the anionic gold species is a gold sulfur complex.

8. A method according to claim 7 wherein the gold sulfur complex is [Au(S₂O₃)₂]³⁻, [Au(SCN)₂]⁻ or [Au(SCN)₄]⁻.

9. A method according to claim 3 wherein the precious metal is gold in the form of a cationic gold species.

10. A method according to claim 1 wherein the conducting polymer is in the form of a polymer membrane, a polymer dispersion or powder.

11. A method according to claim 1 wherein the conducting polymer is in the form of a coating on a support substrate.

12. A method according to claim 1 wherein the conducting polymer is in the form of a textile, cloth or fabric.

13. A method according to claim 1 wherein the conducting polymer is in the form of a coated fibre, a coated particle or a coated microparticle.

14. A method according to claim 1 wherein the conducting polymer is in a colloidal form.

15. A method according to claim 14 wherein the conducting polymer in colloidal form is in the form of a self supporting colloidal dispersion of particles, a self supporting colloidal dispersion of microparticles, a colloidal dispersion of coated particles or a colloidal dispersion of coated microparticles.

16. A method according to claim 1 wherein the conducting polymer is coated onto a resin.

17. A method according to claim 16 wherein the resin has sufficient magnetic susceptibility to facilitate magnetic separation.

18. A method according to 17 wherein the resin is a magnetic resin of the MIEX® type.

19. A method according to claim 1 wherein the conducting polymer is polypyrrole, polythiophene, polybisthiophene, poly 3-methythiophene or polyaniline.

20. A method according to claim 1 wherein the conducting polymer contains a dopant selected from the group consisting of PTS, S-PHE (sulfonated β-hydroxyether) chloride (Cl⁻) or perchlorate (ClO₄⁻) ions or poly NiPAAM/AMP (poly(isopropyl acrylamide)-poly(acrylamido)-2-methylpropane sulfonic acid).
